(19) United States
(12) Patent Application Publication
(10) Pub. No.: US 2011/0210143 A1
(43) Pub. Date: Sep. 1, 2011

(54) BEVERAGE POUCH AND METHOD OF USE

(75) Inventor: Charles H. Jones, Roswell, GA (US)

(73) Assignee: TEVENTI, LLC, Roswell, GA (US)

(21) Appl. No.: 13/127,477

(22) PCT Filed: Nov. 12, 2009
(86) PCT No.: PCT/US09/06067

§ 371 Date: May 4, 2011

Related U.S. Application Data
(60) Provisional application No. 61/193,273, filed on Nov. 12, 2008.

(51) Int. Cl. B65D 25/08; B65D 30/22; B65D 33/16; B65D 30/20; B65D 33/10; B65D 25/00; B67D 7/00; B01F 13/00

(52) U.S. Cl. 222/1; 206/222; 383/38; 383/66; 383/120; 383/7; 220/737; 366/348; 222/105; 222/183; 206/219

(57) ABSTRACT

A pouch for dispensing of a usable liquid comprises at least first and second compartments, the first and second compartments separated from each other by a first rupturable seal; which ruptures upon application of a force so that the first and second compartments are in communication with each other. The first compartment has a fill port with a tamperproof seal and is either empty or contains a gas such as air or an inert gas. The second compartment has at least a first material therein to be mixed with one or more liquids to be introduced into the first compartment via the fill port to form the usable liquid.

This application claims priority under 35 U.S.C. 119(e) based on provisional patent application No. 61/193,273, filed in Nov. 12, 2008 and which is incorporated in its entirety by reference herein.

### FIELD OF INVENTION

The present invention relates to pouch having at least two compartments, one essentially empty and one for filling by a user to create a liquid to be consumed or used by a user or other person.

### BACKGROUND ART

In the prior art, there are a number of different consumable liquid pouch constructions with frangible seals that are broken for mixing and creation of a liquid to be consumed. One example of such a construction is shown in U.S. Pat. No. 7,055,683 to Bourque et al., which is herein incorporated in its entirety by reference. In this construction two different flavored liquids are stored in the pouch. The frangible seal of the pouch can be broken such that the liquids can be mixed and then accessed via a fitment in communication with one of the pouches.

Another pouch designed for consumable liquids are those containing a powdered mix such as a margarita mix. These pouches have a single compartment and are designed to be filled with a liquid to create the desired beverage and then dispensed. One problem with these pouches is that the material inside the bag is that the material can be subject to oxidation and degradation over time. This is primarily because the surface to volume ratio is high inside the pouch. Also, the material inside these pouches can spill once the pouches are opened.

Problems with this type of pouch construction is that they offer the consumer only limited options in the type of liquid being created and made available. Therefore, there is a need to provide pouches, which are more flexible in the type of liquid that can be delivered. The present invention responds to this need by providing a pouch that allows a user to fill one of the pouch compartments to create a user-defined liquid for consumption or other use.

### SUMMARY

A first object of the invention is a pouch for providing a liquid to a user that can be consumed or used for other purposes.

Another object of the invention is a method of creating a usable liquid using the pouch.

Yet another object of the invention is a device for holding the pouch to facilitate consumption of the liquid contained therein.

Other objects and advantages will become apparent when reading the description of the invention as detailed below.

In satisfaction of the foregoing objects and advantages, the present invention provides, in one aspect, a pouch for dispensing of a liquid that can be either consumed by a user or other person, e.g., something that one would drink. The liquid could also be something that would not necessarily be consumed by a person, e.g., a cleaning or sanitizing liquid that could be used on by a user for personal use or to clean or sanitize some other object or the like. The term “usable” is meant to cover uses wherein the liquid formed in the pouch could be consumed by a user or wherein the liquid formed in the pouch would have a use that would not entail consumption by a person, e.g., cleaning, sanitizing, or the like of a person, animal, or inanimate object, surface, or a medical treatment.

The pouch further comprises at least first and second compartments, the first and second compartments separated from each other by a first rupturable seal; which ruptures upon application of a force so that the first and second compartments are in communication with each other.

The first compartment has a fill port, preferably with a tamperproof seal, and being empty or containing a gas such as air or an inert gas. The second compartment has at least a first material therein to be mixed with one or more liquids or solids to be introduced into the first compartment via the fill port to form the usable liquid.

In another embodiment, the pouch can comprise at least a third compartment separated from the first compartment by a second rupturable seal, the third compartment having at least a second material to be mixed with the one or more liquids and the first material for forming the usable liquid. The seals can be configured in a variety of locations between the various compartments, either horizontally, vertically or the like.

The pouch can include a gusset edge along one side of the pouch or some other means of support so that the pouch can stand alone.

Examples of the first material include a liquid concentrate of soup, tea, coffee, water purification compounds, tisanes, nutraceutical compounds, broth, effervescent agents, fruit drinks or nectars, a beverage mix suitable for mixing with alcohol, a powdered material such as a soup mix, pancake/waffle/biscuit mix, a powdered drink mix, medically-related materials that, when combined with the liquid provide some medicinal use, or any other type of product that can be used with a liquid to form a usable liquid. Another application would be to use a water activated foam in the sequestered compartment. This foam could expand on the order of 20-40 times its volume once mixed with water and the pouch could act like a sandbag. The liquid can be water or water and a combination of some other liquid such as alcohol.

The pouch can have a handle for carrying the pouch, wherein the handle can be a flap forming an opening between the flap and pouch, a through opening in the pouch material for gripping, and the like.

Another aspect of the invention is a method of creating a usable liquid. This method includes the steps opening the fill port and filling the first compartment with one of more liquids and closing the fill port. Then, the seal between the first and second compartments is ruptured so that the first material mixes with the one or more liquids to form the usable liquid for dispensing upon opening of the fill port. The method can also be employed with pouches that employ more than two compartments and more than one rupturable seal. Once the usable liquid is created, the liquid can be dispensed from the fill port for whatever use is appropriate. Examples of the liquid are those described above. Likewise, the first material can be the ones described above. When dispensing the usable liquid, the pouch can be held in a container so that the usable liquid can be dispensed from the fill port by gravity. The pouch can be provided with a stand alone feature so that it can be set on a surface and stand without any additional support for dispensing or storage. While it is preferred that the force is applied to the larger compartment, the force can be applied to either the first or second compartment or one of multiple compartments when more than two compartments are present.

Another aspect of the invention is a beverage pouch holder comprising a holder body having a top open end and a closed bottom, a slot at the top end adapted to receive a port of a beverage pouch, and an opening at the bottom adapted to receive the port of the beverage pouch; and optionally a lid adapted to cover the top open end and a handle to lift the holder when containing a beverage pouch.

The holder can further comprise a cup having a height less than a height of the holder, the cup adapted to fit within the holder body to receive a pouch in the cup or, in an inverted position, support a bottom of a pouch placed in the holder, or to support the bottom of the holder when the port extends from the opening in the bottom of the holder. The invention also entails a method of dispensing a beverage from a pouch comprising providing a beverage pouch with a port at one end thereof. The pouch is oriented in the holder so that the port is either in the slot or the opening for dispensing of beverage from the pouch. The port can be equipped with a dispensing tap when the port is in the opening.

### BRIEF DESCRIPTION OF THE DRAWINGS

FIG. 1A is a schematic view of a first embodiment of the invention showing a exemplary pouch and

FIG. 1B is a side view of the pouch of FIG. 1.

FIG. 2 is schematic view of a second embodiment of the invention showing a pouch with additional compartments.

FIG. 3 is a schematic view of a third embodiment of the invention showing a pouch with a handle.

FIG. 4 is a perspective view of a first embodiment of a holder for a pouch of the invention.

FIG. 5 shows an exploded view of FIG. 4 that shows the lid, two different types of pouches, and the holder itself.

FIG. 6 is perspective view of a holder and lid.

FIG. 7 shows a perspective view of a cup designed to fit into the holder.

FIGS. 8A-8C are front, side, and back views of the holder of FIG. 6.

FIG. 9 is a schematic view of yet another embodiment of the pouch of the invention with an island configuration.

### DESCRIPTION OF THE PREFERRED EMBODIMENTS

The invention has a number of features which provide significant advantages over the prior art. One feature is that the inventive pouch comprises two or more compartments of which at least one compartment is void and the other compartment(s) are sealed and contain a liquid or powder concentrate. To the voided portion is attached a fitting with a removable cap or closure. When the user removes the closure and fills the empty compartment with liquid, preferably water, replaces the closure, and presses slightly on one or more parts of the pouch, e.g., the previously empty but now filled section, the force ruptures the seal(s) between the sections/compartments producing a beverage or other liquid ready for consumption or other use. The user needs only to again remove the cap and pour into a vessel for consumption, drink directly from the opening, or use in some other capacity.

Again, the invention has a number of significant advantages over the existing pouches available for providing a usable liquid. Beverages (non-carbonated), soups, dehydrated foods, water purification additives, and nutritional elixirs may be reduced in weight dramatically with the removal of substantially all of the water. This removal or reduction (known as concentrating) results in tremendous energy savings directly due to fuel conservation in transport, shelf space reduction (less space required to warehouse or display products), and lengthy shelf life or stability. Nearly all areas of the United Stated benefit from readily available and high quality potable water sources to add to the larger portion of the inventive pouch. In addition, other liquids may be added that are not reducible beyond a given level, e.g. alcohol and ice.

The package, constructed of flexible laminated material, allows for ease of storage when first mixed and increased flexibility as it is dispensed or consumed or otherwise used. The inventive pouch readily molds itself into areas where traditional vessels, due to fixed configuration, simply will not fit.

The package may be placed inside a thermal protective housing to accept boiling or very hot liquids for soups or hot served beverages such as cocoa or coffee. Additionally the package may be frozen to be consumed or used at a later time still cold. If the package is placed in the thermal sleeve, then melting is retarded and the package may take some time to fully thaw. This is ideal for extended trips.

Since the package is constructed of very lightweight plastic-based laminates, it poses no risk or danger for areas such as beaches, pools, playgrounds etc. as glass and metal do. The package may be recycled by plastics recyclers that specialize in reusing traditionally non-recyclable materials by shredding, melting, or transforming into new objects. One example of such an entity is TerraCycle Corporation.

Since an average liquid concentration factor is at least 11+1, the use of the invention realizes a savings of no less than 11/12 of the transport energy and 11/12 of the material required if 12 separate containers were used. If dried materials are utilized the savings are far greater. Since a good and readily available recycling methodology exists, the inventive pouch is indeed a full circle application.

The pouch is comprised of layers or laminates of plastic material which are fused together to form a multi-compartment pouch as is known in the art, see the Boudreau patent mentioned above as one example. Separate formed section(s) within the pouch are filled with a concentrate (either liquid or powder) while a larger section is empty, save for air or inert gas or a vacuum. The larger area has affixed to it a fitting, preferably with a tamper-evident closure, that provides the means to seal the pouch from contaminants until its use. The user removes the closure, breaking the tamper evident seal, and fills the empty section with liquid, preferably water, replaces the closure, and places a slight pressure on the now filled section, causing the sealed compartment(s) to rupture and mix with the liquid. Of course, the liquid may be hot or cold and the user may add ice into the opening to chill the final product.

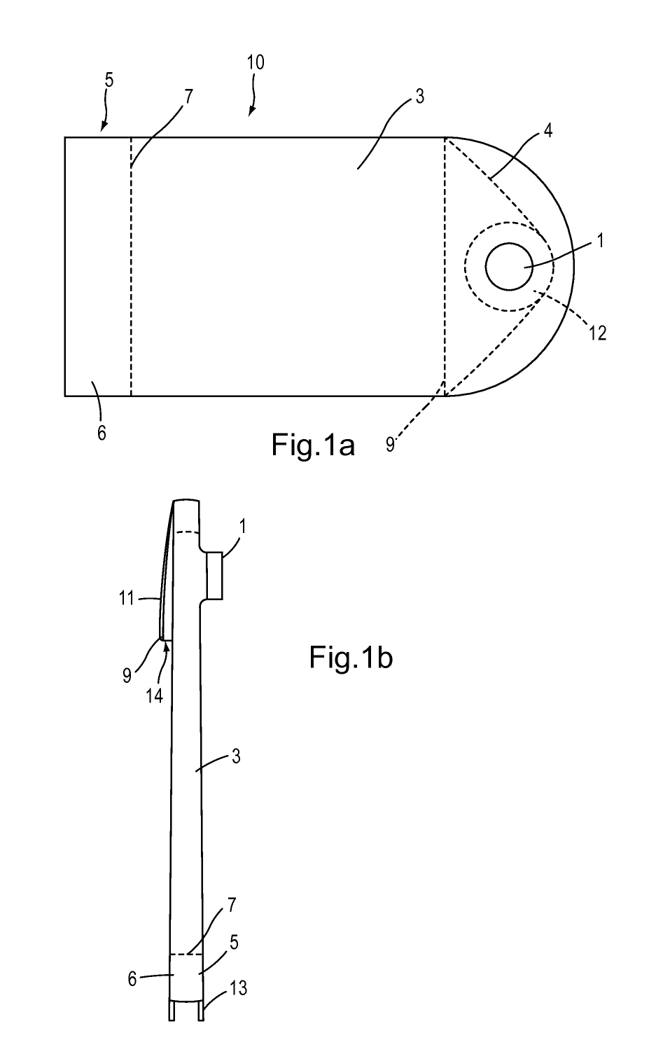

FIG. 1 shows a schematic example of one embodiment of the invention as a pouch 10, with a closure or fill port 1. A first compartment 3 is separated from a second compartment 5 by a rupturable seal 7. The first compartment 3 is delineated by the edges of the bags and line 4 surrounding the fill port 1. The second compartment 5 contains the material 6 intended to make the liquid to be consumed or used, with the first compartment 3 being either evacuated or containing an inert gas, or air if so desired. Once the fill port 1 is opened and the compartment 3 is filled with the desired liquid or liquids or even solids such as ice, the seal 7 is ruptured by application of a force to either or both compartments and the material in compartment 5 mixes with the materials introduced into compartment 3. The fill port 1 can be opened and the thus-formed usable liquid can be dispensed for use. The fill port 1 can also include a flange 12 around it for strength during handling. The advantage of having the second compartment 5 house the material 6 to be mixed with the liquid is that the exposure of the material 6 to the environment is reduced. For example, merely placing the material into the first compartment means that the material can be in contact with air or other compounds that may degrade the material during storage. Keeping the material to be used to form the usable liquid in a small enclosure minimizes any adverse effects that the environment may cause.

FIGS. 1 and 1A also shows the end 9 of a flap 11 positioned on the back side of the pouch. The flap is another piece of material that forms a chamber 14 between the material and the outer surface of the pouch for carrying purposes. This is particularly desirable on smaller size pouches (under 4 liters). The chamber is formed by adhering an additional section of plastic material to provide a “hand-hold” to carry the pouch as well as facilitate the filling operation. Of course, other handle type configurations can be employed as would be known in the art, e.g., use the pouch itself as a handle by welding certain portions together and forming a throughole in the welded portions. It should also be understood that the handle is optional and the pouch just handled by its existing features and without any special feature to facilitate holding.

The materials of the pouch can be any materials that are suitable for holding the intended material for the compartments. Likewise, the fill port can be any type of a closure that would be adaptable for connection to the plastic materials used to make the pouch and can be placed in various locations on the pouch. Examples include just screw caps or taps such as found in wine-in-a-box products. The pouch can also include the appropriate printing and the like for advertising, meeting government regulations, directions, etc. In one embodiment, the pouch can be made so that one side is clear so that the contents of either compartment can be seen. The other side can be designed to accept printing so that the appropriate advertising, product details, nutrition facts, etc. can be displayed.

FIG. 1A shows the pouch bottom 11 with a stand alone feature 13 such as gussets to that the pouch can remain upright between dispensing. An example of a gusset is found in U.S. Pat. No. 7,306,095 to Bourque et al. Also, the Bourque et al. patent is an example of the rupturable seal described above. Other rupturable seals as would be known in the art can also be employed in the inventive pouch.

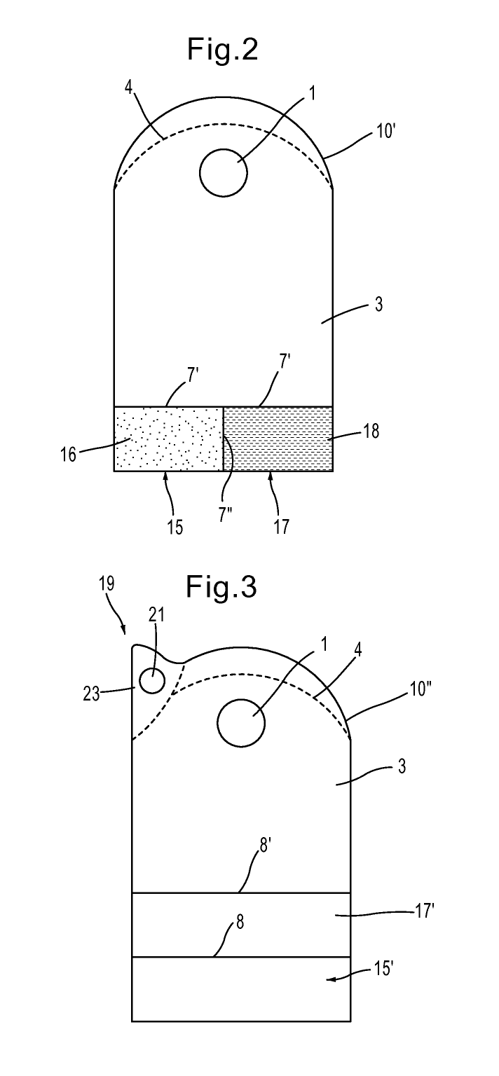

FIGS. 2 and 3 show alternative embodiments that use more than two compartments. FIG. 2 shows a pouch 10′ with first compartment 3, with second and third compartments 15 and 17 and seals 7′. A powder 16 is shown in compartment 15 and a liquid 18 is shown in compartment 17 as examples of the type of materials that can be employed with the pouch 10. Rupturing seals 7′ mixes the materials 16 and 18 of compartments 15 and 17 with the filled compartment 3.

In FIG. 3, the compartments 15′ and 17′ of pouch 10″ are oriented in a different fashion such that the rupturable seal 8′ is between the compartments 15′ and 17′. In this way, the order of rupturing can be varied if this is important when mixing the various materials. That is, it may be desirable to mix the materials of compartments 15′ and 17′ prior to mixing with the liquid filled in compartment 3.

In yet a further alternative, the rupturable seals could be serial in nature such that the third compartment would be separated from the second compartment by a rupturable seal and the second compartment would be separated from the first compartment by a rupturable seal. This embodiment is shown in FIG. 2, where the rupturable seal 7″ would replace the seal 7′ that is between the compartment 3 and compartment 17. This can result in a serial mixing of materials 16 and 18 first, and then mixing with the liquid in compartment 3. Alternatively, the seal between compartment 15 and 3 can be ruptured first so that the liquid/solid in compartment 3 mixes with material 16 first and then the seal 7″ can be broken to add the material 18.

FIG. 3 also shows a handle feature 19, which is a hole 21 formed in a sealed portion of 23 of the pouch sides.

Additionally, holders are designed into which the pouch may be placed to facilitate filling and dispense. These holders may be formed of a double-wall construction allowing the entrapment of insulation material or refrigerant such as “blue-ice”. One holder has the versatility to allow normal pouring such as a pitcher, but when the fill port is replaced with a “tap” and placed top side down, the holder acts as a reservoir for easy dispense. A fill port or tap can be removed and reserved to facilitate complete drainage when used in this position.

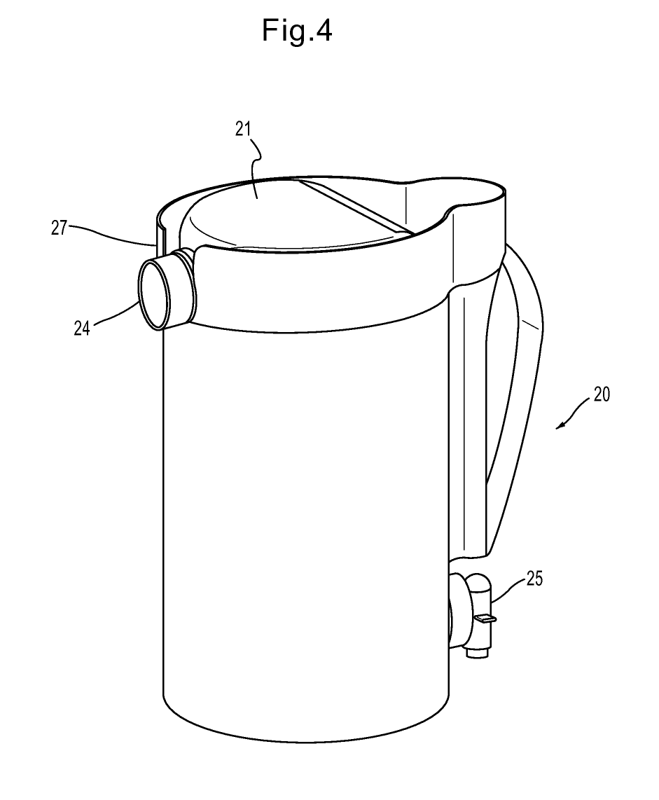

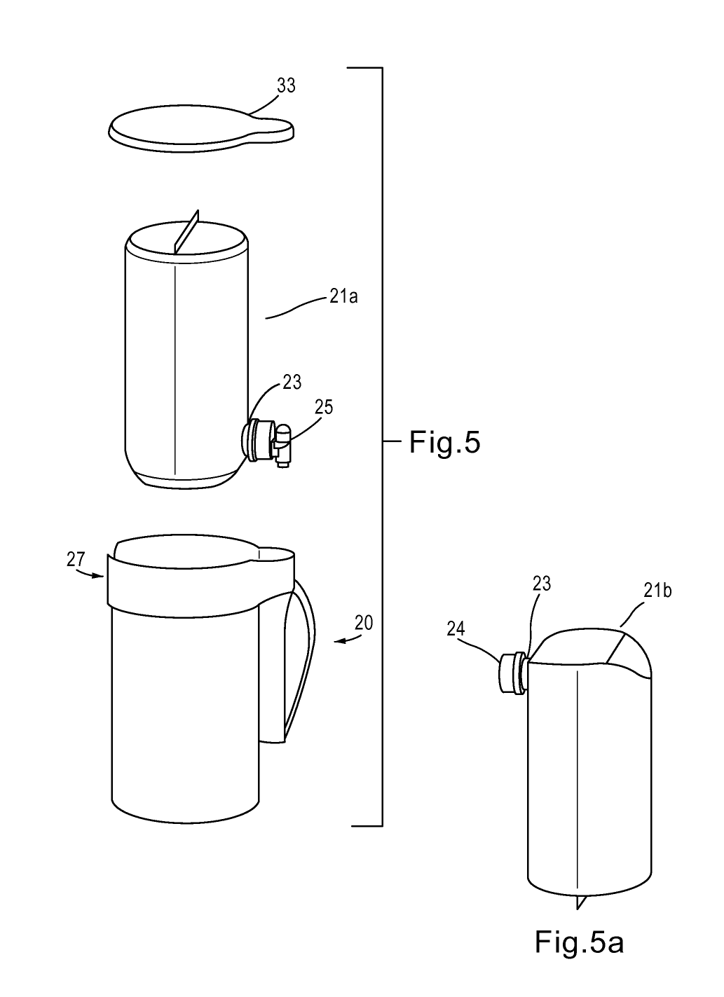

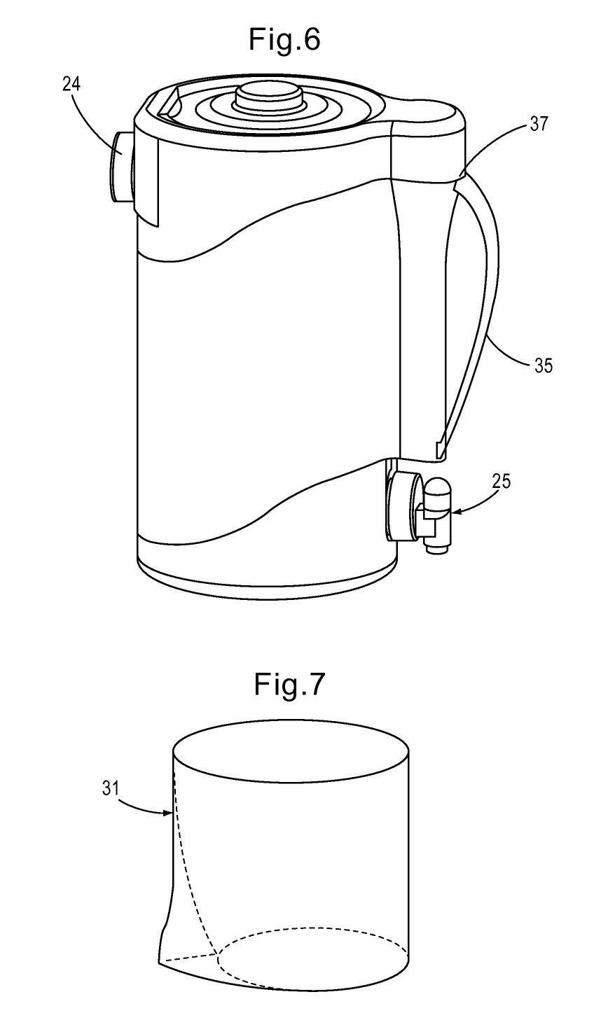

FIGS. 4-8C show an exemplary holder 20, which is pitcher shaped. The holder is designed to receive pouch 21a, which is inserted for either dispensing via a tap 25 using the port 23, or pouring as a pitcher, 21b, see FIG. 5A, using the port 23. The port 23 for the pitcher mode can have cap 24 to close the port, with the tap 25 taking the place of the cap when the holder is used in the tap dispensing mode. The holder 20 has a slot 27 on its upper end to receive the port 23 for pouring and an opening 29 on its lower end to receive the port to extend through the holder 20 and be linked with a dispensing tap 25.

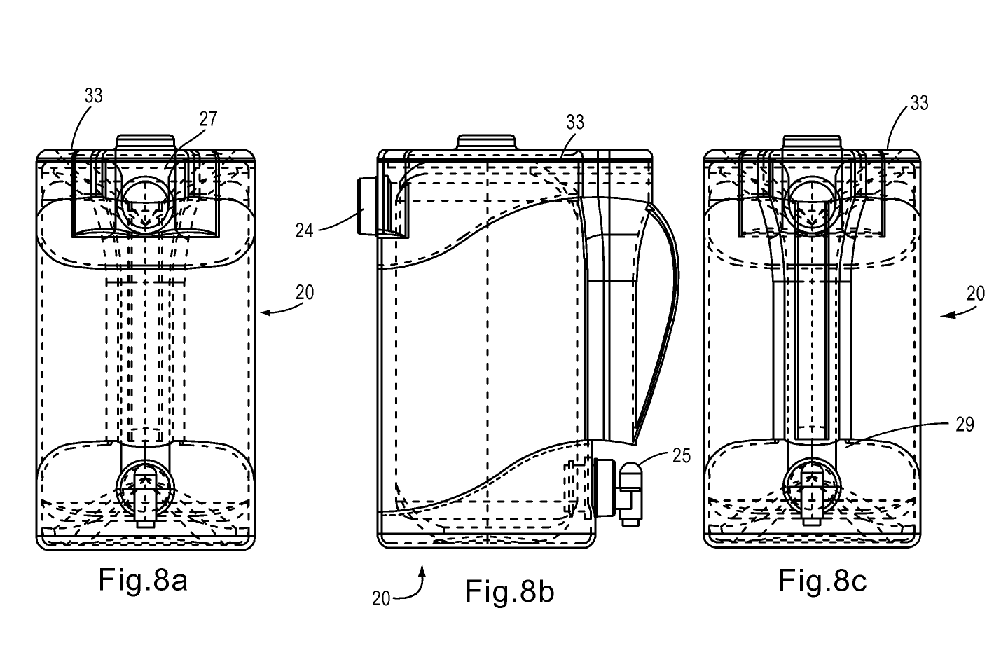

A cup 31 is shown in FIG. 7 that is sized to be inserted into the holder 20 and has a curved inside to assist in flow of liquid from the pouch when used in the pitcher mode. The cup 31 can also be inverted and placed under the holder 20 to raise the tap 25 from a surface to facilitate dispensing therefrom. The cup can also be inverted and placed in the holder to accommodate a smaller size pouch. The holder can be made with a clear portion in its side wall so that the pouch inside the holder can be observed for its state of emptiness. The holder is also equipped with a lid 33 to retain the pouch in the pitcher mode. The holder also includes a handle 35, which is shown in its extended position in the Figures. However, the holder has a slot 37, see FIG. 8A, which can receive a portion of the handle so that it can lie flat against the side of the holder and be out of the way if the pitcher mode is not being used.

With reference again to FIG. 1, compartment 5 is typically defined by the end opposite the fitting or orifice and may touch a portion of one of both of the sides, with the side defined as the longer dimension of the pouch. Compartment 5 may also be configured as an “island” or “islands” not touching sides or ends but defined by the seal created from the front and back of the inventive pouch.

Compartment 5 may also be subdivided into sections requiring varying degrees of force to break the seal. This is very useful in the application of user-preferred additives such as sweetener, flavoring, coloring and other enhancements. In this mode, one seal between two compartments may break initially to create an initial mixing of the liquids and another seal with a third compartment could rupture later so that the material in the third compartment is not mixed until the liquid and first material are mixed.

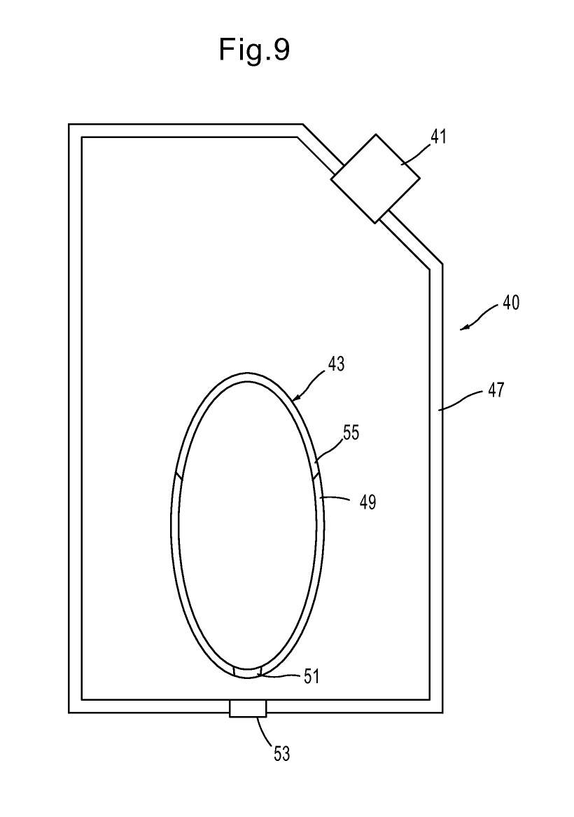

FIG. 9 shows another embodiment of a pouch using an island compartment that is surrounded by the compartment being filled by the user. Such a pouch is designated by the reference numeral 40 and includes a fill port 41 that is located at the corner of the pouch. The pouch 40 also includes an island compartment 43, which does not touch the sides of the pouch. A surrounding compartment 45 is provided, which envelops the compartment 43. In the method of making, the majority of the outer peripheral seal 47 surrounding the compartment 45 and the seal 49 surrounding the compartment 43 are formed, leaving opening 51 in the compartment 43 and opening 53 in the surrounding compartment 45. These two openings are used to fill the island compartment 43 by insertion of a filling nozzle (not shown) through the two openings 51 and 53. Once the island compartment is filled, the opening 51 is immediately sealed. Then, as the filling nozzle retracts from the surrounding compartment 45, the opening 53 is sealed and the pouch is now integral and ready for use. It should be understood that when forming the majority of the seal for the island compartment 43, the frangible or rupturable seal 55 is formed for use of the pouch as described above. The position of the seals and openings for compartment filling and for rupturing are exemplary and other seal/opening configurations can be used.

In operation, one exemplary method, referring again to FIG. 1, would be as follows.

a. The user removes a cap or protective covering from the spout or orifice.

b. The user introduces the material or media to be mixed into compartment 3, such as water, milk, liquor, fruit, flavor, ice or a combination of any of these.

c. The user places sufficient pressure on one or the other filled portion, preferably the larger portion, to rupture the temporary seal or seals separating the sequestered material in compartment 5 and the media in compartment 3.

d. The user then manipulates the now combined portion so as to finish blending and mixing the components to satisfaction.

e. The user then removes the cap or covering from the orifice and dispenses the product easily by grasping the surplus material that results when the previously separated portions are now combined and pours into serving vessels such as cups or glasses or onto cooking surfaces or the user may consume or use the product directly from the orifice. Ice and other additives are readily inserted into the orifice if desired.

The mixed components may be poured or squeezed from the inventive pouch by removing the cap or covering or by affixing a “faucet” to the opening and pouring by operating the faucet. This feature is particularly useful in the larger (5 liters and above) pouches typically employed in food service operations.

One or more of the sealed compartments may contain liquid beverage concentrates of any non-carbonated nature, soups, isotonic, water purification compounds, nutraceutical compounds, effervescent agents, broth, or other food type products. Other uses include: (1) beverages such as liquid concentrates, e.g., teas, tisanes, nutraceuticals, fruit (fresh and frozen) as well as powdered drink mixes; (2) soups such as liquid concentrated broths, clear and with solids, as well as powdered; (3) bar mixes, specialty bar mixes, liquid, powdered and frozen concentrates to which alcohol, water, and other fresh ingredients are added, which may be frozen into slush and served, a sangria mix to which wine is added make a party or summer drink; (4) food: powdered products such as pancake/waffle or biscuit mixes only require the addition of water into the bag to fully prepare the dough-based product for cooking; (5) cleaning/sanitizing materials such as powdered or liquid detergent, disinfectants, and the like that could be used once made for the purpose of treating people, animals or inanimate objects; (6) medical such as dosed media, foodstuffs or beverages to provide small and large scale preventive or curative dispense in relief areas or disadvantaged populations; and (7) water-activated foam in the sequestered compartment; this foam could expand on the order of 20-40 times its volume once mixed with water and the pouch could act like a sandbag.

Other applications that may utilize the inventive pouch include the following.

(i) Disaster—in the event of a large scale disaster, it is far easier to transport hundreds or thousands of gallons of potable water in tankers to a remote site than thousands of cans or bottles of ready to drink or eat containers. The water can be placed into compartment 3 quickly and mixed effectively for immediate use. The empty pouch collapses to a fraction of its size therefore facilitating bulk removal from the site. Water can be bulk heated through many common methods and placed in pouches designed for thermal applications.

(ii) Military operations—due to the extreme light weight of the pouch, emergency rations can be ferried for great distances during operations until water or other intended media is available. With the inclusion of water purification sections, safe water can be made available prior to bursting the concentrate portions.

(iii) Camping/hiking, wherein the lightweight fully contained pouch provides for readily available beverages and food during backpack, canoe, or camping ventures. Again, if water purification is added, the user has complete nutrition at hand, or if only the water purification is included, clean drinking water. The collapsible quality of the inventive pouch makes for complete “pack it in, pack it out” functionality.

(iv) Recreation—for use in all outdoor events such as boating, beaches, tail-gate parties, picnics and the like all the functions of the inventive pouch are in play.

(v) Homeland Security—entire collections of beverage, food, medicine and pure water can be packaged in emergency use containers in the event that traditional supplies are cut off. Additionally, while not a prime use of the inventive pouch, during an isolating emergency event, the empty pouch can be used to effectively store and later dispose of human waste.

The pouch may be formed of any given size desired, with examples being 1, 2, 4 and 10 liter sizes. The smaller sizes can be used in a stand alone condition, with the larger sizes possibly requiring holders such as the one depicted in FIGS. 4-8. Typically, compartment 3 will be larger than compartment 5 and have the input/output spout, fixture or orifice. This is desired since the fluid entering compartment 3 is generally one that will dilute the contents of compartment 5, with compartment 5 often being a concentrate of some sort. This embodiment is also preferred since employing a concentrate in compartment 5 means that less water or other liquid is used and the advantages in terms of energy savings as noted above are realized.

While numerous products may provide concentrate for use, the inventive pouch is singularly unique in providing the entire vessel for transport, mixing, consumption/use and recycle. The inventive pouch requires the addition of mix media into the package by the user to make the product usable. No other product is required or needed for pouch operation other than a temporary housing for safety when used for heated products. The pouch is not limited to food and beverage applications as are stated herein and can be applied in a number of other and useful applications.

As such, an invention has been disclosed in terms of preferred embodiments thereof, which fulfills each and every one of the objects of the present invention as set forth above and provides new and improved pouch, a method for dispensing liquids from the pouch, and a holder for the pouch.

Of course, various changes, modifications and alterations from the teachings of the present invention may be contemplated by those skilled in the art without departing from the intended spirit and scope thereof. It is intended that the present invention only be limited by the terms of the appended claims.

I claim:

1) A pouch for dispensing of a usable liquid comprising:
a) at least first and second compartments, the first and second compartments separated from each other by a first rupturable seal; which ruptures upon application of a force so that the first and second compartments are in communication with each other;
b) the first compartment having fill port and being evacuated or containing a gas such as air or an inert gas,
b) the second compartment having at least a first material therein to be mixed with one or more liquids to be introduced into the first compartment via the fill port to form the usable liquid.

2) The pouch of claim 1, further comprising at least a third compartment having a second rupturable seal, the third compartment having at least a second material to be mixed with the one or more liquids and the first material for forming the usable liquid.

3) The pouch of claim 1, further comprising a gusset edge along one side of the pouch so that the pouch can stand alone.

4) The pouch of claim 1, wherein the first material is a liquid or liquid concentrate of soup, tea, coffee, water purification compound, tisanes, nutraceutical compounds, soup, broth, effervescent agents, fruit drink or nectars, a beverage mix suitable for mixing with alcohol, a powdered material such as a soup mix, pancake/waffle/biscuit mix, a powdered drink mix, cleaning/sanitizing materials, that when combined with a liquid can be used for these purposes, a water-activated foam that when combined with water can create a sandbag-like pouch, medically-related materials that, when combined with the liquid provide some medicinal use, or any other type of product that can be used with a liquid to form a usable liquid.

5) The pouch of claim 1, further comprising a handle for carrying the pouch, wherein the handle can be a flap forming an opening between the flap and pouch, a through opening in the pouch material for gripping, and the like.

6) A method of creating a usable liquid comprising the steps of:
providing the pouch of claim 1;
opening the fill port and filling the first compartment with one of more liquids;
closing the fill port; and
rupturing the seal between the first and second compartments so that the first material mixes with the one or more liquids to form the usable liquid for dispensing upon opening of the fill port.

7) A method of creating a usable liquid comprising the steps of:
providing the pouch of claim 2;
opening the fill port and filling the first compartment with one of more liquids;
closing the fill port; and
rupturing the first and second rupturable seals so that the first and second materials mix with the one or more liquids to form the usable liquid for dispensing of the usable liquid upon opening of the fill port.

8. The method of claim 7, including the step of dispensing the usable liquid.

9. The method of claim 7, wherein the one or more liquids include water or water and an alcohol.

10. The method of claim 7, wherein the first material is a liquid or liquid concentrate of soup, tea, coffee, water purification compound, tisanes, nutraceutical compounds, soup, broth, effervescent agents, fruit drink or nectars, a beverage mix suitable for mixing with alcohol, a powdered material such as a soup mix, pancake/waffle/biscuit mix, a powdered drink mix, cleaning/sanitizing materials, that when combined with a liquid can be used for these purposes, a water-activated foam that when combined with water can create a sandbag-like pouch, medically-related materials that, when combined with the liquid provide some medicinal use, or any other type of product that can be used with a liquid to form a usable liquid.

11. The method of claim 7, wherein the pouch is held in a container so that the usable liquid can be dispensed from the fill port.

12. The method of claim 7, wherein the pouch is provided with a stand alone feature so that it can be set on a surface and stand without any additional support.

13. The method of claim 7, wherein the seal is ruptured by applying a force to either the first or second compartment.

14. The method of claim 8, wherein the seals are ruptured by applying a force to either the first or second or third compartment.

15. The pouch of claim 2, wherein the second rupturable seal is either between the first and third compartments or the second and third compartments.

16. The pouch of claim 2, wherein the second compartment is between the first and third compartments so that the second rupturable seal is between the second and third compartments.

17. A beverage pouch holder comprising:
a) a holder body having a top open end and a closed bottom;
b) a slot at the top end adapted to receive a port of a beverage pouch;
c) an opening at the bottom adapted to receive the port of the beverage pouch; and optionally
d) a lid adapted to cover the top open end and a handle to lift the holder when containing a beverage pouch.

18. The holder of claim 17, further comprising a cup having a height less than a height of the holder body, the cup adapted to fit within the holder body to receive a pouch in the cup or, in an inverted position, support a bottom of a pouch placed in the holder, or to support the bottom of the holder when the port extends from the opening in the bottom of the holder.

19. A method of dispensing a beverage from a pouch comprising:
a) providing a beverage pouch with a port at one end thereof,
b) providing the holder of claim 17, and
c) orienting the pouch so that the port is either in the slot or the opening for dispensing of beverage from the pouch.

20. The method of claim 19, wherein the port is equipped with a dispensing tap when the port is in the opening.

21. The pouch of claim 1, wherein the second compartment is surrounded by the first compartment.
